(19) United States
(12) Patent Application Publication
(10) Pub. No.: US 2009/0247736 A1
(43) Pub. Date: Oct. 1, 2009

(54) Luminous Compound Containing Lanthanide Ion

(75) Inventors: Koki Nakamura, Shizuoka (JP); Hirofumi Fukunaga, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/886,717

(22) PCT Filed: Mar. 20, 2006
(86) PCT No.: PCT/JP2006/306049

§ 371 Date: Sep. 20, 2007

(30) Foreign Application Priority Data
Mar. 22, 2005 (JP) 2005-082089
Dec. 9, 2005 (JP) 2005-356942

(51) Int. Cl. C07F 5/00

(52) U.S. Cl. 534/15

(57) ABSTRACT

A luminous compound represented by the following formula (I):

Met-COG-ChHet Formula (I)

wherein Met represents a group containing a lanthanide ion, COG represents a heterocyclic group bonded directly to the lanthanide ion contained in the group represented by Met, and ChHet represents a group having a heterocycle, where ChHet is preferably a group that conjugates with COG.

### TECHNICAL FIELD

The present invention relates to a luminous compound containing lanthanide ion; particularly to a novel luminous compound useful in the fields of technologies for marking trace components, flat panel display fields, illumination material fields, and fiber/cloth fields.

### BACKGROUND ART

A lanthanide complex is known to have such unique characteristics as not to be seen in usual luminous organic dyes, for example, and that the emission of a lanthanide complex has an extremely large stokes shift, so that the complex is resistant to concentration quenching, and the emission has a long excitation life, called delayed fluorescence. As to the use of lanthanide complex compounds, typified by europium and terbium complexes, that have an emission spectrum in the visible region, many proposals have been offered so far. For example, marker compounds are disclosed in “Monthly Publication, Material Integration,” (K.K.) TIC, March (2004), Vol. 17, No. 3, and in JP-A-2003-325200 (“JP-A” means unexamined published Japanese patent application); and, application of a lanthanide compound to color-display color filters is disclosed in JP-A-2001-143869.

The excitation wavelengths of current lanthanide complexes are in the ultraviolet region, and a large part of lanthanide compounds that have been known so far have an excitation maximum at wavelengths lower than 350 nm. To have an excitation wavelength in ultraviolet region means limitation on a type of excitation light source, giving rise in the problems that necessitate use of an expensive light source, in many cases.

In addition, in such applications as biological imaging and detection for trace components in living bodies, there is concern about damage to living bodies or target substances, by high-energy ultraviolet light. Because there are many components in living bodies that absorb light in the ultraviolet region, and because, as for light scattering, a light having a longer wavelength is less vulnerable to light scattering, an excitation light having a wavelength in the visible region is said to be better to obtain information in the depth direction compared with having a wavelength in the ultraviolet region.

As to the application of these luminous compounds to color display color filters, a usual polarizing plate transmits almost no ultraviolet light, and therefore the usable part among the light that reaches the color filter is almost limited to the visible region, in liquid crystal display use. Also, it is possible to use ultraviolet light emission in the use of a color converting filter for organic EL displays. However, generally, blue light emission is rather advantageous from the viewpoint of the life of elements. The purpose of the filter, therefore, is to convert blue light into green light or red light. In this case, visible light is used as the exciting light.

As mentioned above, almost all lanthanide complexes that have been known so far have respective excitation wavelengths in the ultraviolet region. Therefore, in aiming to attain the above application, it is strongly desired to develop a lanthanide complex that can be excited by visible light or light close to visible light.

A europium complex having an excitation maximum at 402 nm in solution is described in “Angewandte Chemie, International Edition,” (2004), Vol. 43, p. 5009, and there is also the description that this europium complex gives a high emission quantum yield. However, it is known that it is not easy to synthesize analogues of this europium complex, and this europium complex has the drawback that the degree of freedom in control of the excitation wavelength is very low.

### DISCLOSURE OF INVENTION

Thus, the present invention provides a series of ligand dyes and a series of light-emitting lanthanide complex compounds that allow use of an excitation light having a wavelength in the visible light region, or the region close to it, as a cheaper and easily accessible light source, and that allow easy adjustment of their excitation wavelength.

According to the present invention, there is provided the following means:

(1) A luminous compound represented by the following formula (I):

Met-COG-ChHet Formula (I)

wherein Met represents a group containing a lanthanide ion, COG represents a heterocyclic group bonded directly to the lanthanide ion contained in the group represented by Met, and ChHet represents a group having a heterocycle, where ChHet is preferably a group that conjugates with COG.

(2) The luminous compound according to the above (1), wherein the group represented by COG in the formula (I) is a group represented by the following formula (II):

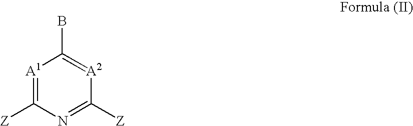

wherein B represents a bond bonded to the group represented by ChHet; A¹ and A² each independently represent a nitrogen atom or ═C(—R¹)—, in which R¹ represents a hydrogen atom or a substituent; and Z represents a group having at least one atom or atomic group bonded to the lanthanide ion contained in the group represented by Met.

(3) The luminous compound according to the above (2), wherein the group represented by the above formula (II) is a group represented by the following formula (III) or (IV):

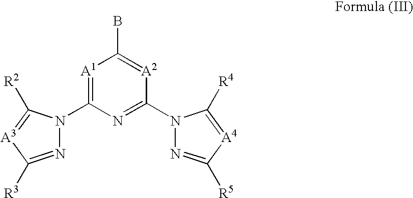

wherein B represents a bond bonded to the group represented by ChHet; A¹, A², A³, and A⁴ each independently represent a nitrogen atom or ═C(—R¹)—, in which R¹ represents a hydrogen atom or a substituent; and R², R³, R⁴, and R⁵ each independently represent a hydrogen atom or a substituent;

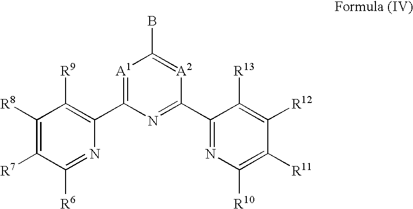

wherein B represents a bond bonded to the group represented by ChHet; A¹ and A² each independently represent a nitrogen atom or ═C(—R¹)—, in which R¹ represents a hydrogen atom or a substituent; and R⁶, R⁷, R⁵, R⁹, R¹⁰, R¹¹, R¹², and R¹³ each independently represent a hydrogen atom or a substituent.

(4) The luminous compound according to the above (I), wherein the group represented by ChHet in the formula (I) is a group represented by the following formula (V):

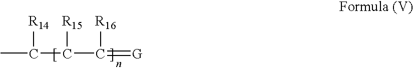

wherein R¹⁴, R¹⁵, and R¹⁶ each independently represent a hydrogen atom or a substituent, and R¹⁴ and R¹⁵, R¹⁵ and R¹⁶, and R¹⁴ and R¹⁶, respectively, may bond with each other to form a ring; n denotes 0, 1, or 2; and G represents an atomic group necessary to form a five- or six-membered nitrogen-containing heterocycle, which heterocycle may form a condensed ring or may be combined with R¹⁴, R¹⁵ or R¹⁶ to form a ring.

(5) The luminous compound according to the above (2), wherein, in formula (II), at least one of A¹ and A² represents a nitrogen atom.

(6) The luminous compound according to any one of the above (1) to (5), wherein the lanthanide ion contained in the group represented by Met is an ion of a metal selected from the group consisting of neodymium, samarium, europium, gadolinium, terbium, and dysprosium.

(7) The luminous compound according to any one of the above (1) to (5), wherein the lanthanide ion contained in the group represented by Met is a europium ion or a terbium ion.

(8) A ligand dye represented by formula (II-b):

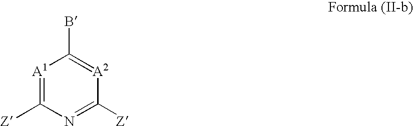

wherein B′ represents a group containing a heterocycle; A¹ and A² each independently represent a nitrogen atom or ═C(—R¹)—, in which R¹ represents a hydrogen atom or a substituent; and Z′ represents a group containing at least one atom or atomic group which is capable of binding with a lanthanide ion contained in a group having lanthanide ion.

(9) A ligand dye represented by formula (III-b) or (IV-b):

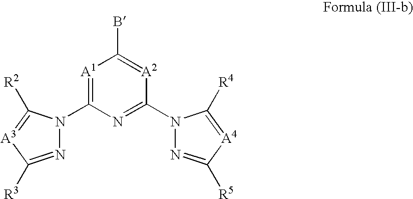

wherein B′ represents a group containing a heterocycle; A¹, A², A³, and A⁴ each independently represent a nitrogen atom or ═C(—R¹)—, in which R¹ represents a hydrogen atom or a substituent; and R², R³, R⁴, and R⁵ each independently represent a hydrogen atom or a substituent; and

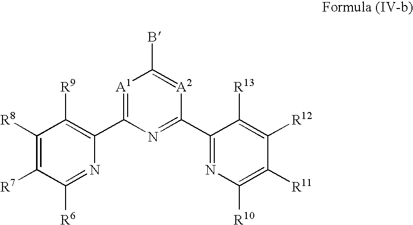

wherein B′ represents a group containing a heterocycle; A¹ and A² each independently represent a nitrogen atom or ═C(—R¹)—, in which R¹ represents a hydrogen atom or a substituent; and R⁶, R⁷, R⁸, R⁹, R¹⁰, R¹¹, R¹², and R¹³ each independently represent a hydrogen atom or a substituent.

The luminous compounds of the present invention can use, as excitation light, light in the visible region, or light having a wavelength in the vicinity of the visible region, despite that these lights are not used for conventional lanthanide complexes. Namely, a light source that is inexpensive and easily available may be used. Further, the ligand dyes of the present invention may be used not only as ligands for lanthanide ions but also as dyes in various known applications. For example, the ligand dyes according to the present invention can be used in the fields of trace-component detection, fluorescence ink, and others, because they have a high molar absorption coefficient, a sharp absorption spectrum, and high fluorescence intensity.

The compound of the present invention may be applied in various fields using a luminescent phenomenon. Particularly, because the compound can be excited by a visible light source, which has been regarded as difficult for use in excitation, it can expand the range of uses in the fields of marking and detection of trace components, and in flat panel displays, such as liquid crystal displays and organic EL displays. Also, in the field of illumination materials, it may be applied to, for example, hue control of illumination light. Also, this compound enables manufacturing of fibers that exhibit unprecedented color tastes, by utilizing the large stokes shift of the compound, and the compound can therefore provide new seeds also in the clothing and fashion fields.

Other and further features and advantages of the invention will appear more fully from the following description.

### BEST MODE FOR CARRYING OUT INVENTION

In the following, the present invention will be explained in detail.

The luminous compound of the present invention is a compound represented by formula (I).

Met-COG-ChHet Formula (I)

In formula, Met represents a group containing a lanthanide ion; COG represents a heterocyclic group bonded directly to the lanthanide ion contained in the group represented by Met; and ChHet represents a group having a heterocycle. Herein, it is preferred that ChHet be conjugated with COG.

No particular limitation is imposed on the lanthanide ion contained in the group represented by Met, and the lanthanide ion is preferably an ion of a metal selected from the group consisting of neodymium, samarium, europium, gadolinium, terbium, and dysprosium, and more preferably the lanthanide ion is a europium ion or a terbium ion.

The group represented by Met may be a lanthanide ion itself or may contain a group that is bonded to the lanthanide ion but is other than COG-ChHet (hereinafter, this “group that is bonded to the lanthanide ion but is other than COG-ChHet” is referred to as a “binding group J”). When Met contains the binding group J, examples of the binding group J include phosphines (for example, triphenylphosphine and trioctylphosphine), phosphine oxides (for example, triphenylphosphine oxide, tributylphosphine oxide, and trioctylphosphine oxide), amines (for example, triethylamine, tetramethylethylenediamine, and pentamethyldiethylenetriamine), diketones (dibenzoylmethane, thenoyltrifluoroacetone, acetylacetone, and 3-heptafluorobutyrylcamphor), carboxylic acids (for example, acetic acid, propionic acid, and benzoic acid), imides (bisnonafluoro-1-butanesulfonimide, benzenesulfonimide, 1,1,2,2,3,3-hexafluoropropane-1,3-disulfonimide, and trifluoromethanesulfonimide), ethers (for example, dimethoxyethane, diethylene glycol, and dibenzo-18-crown-6-ether), and thioethers (for example, dimethylsulfide, and 1,4,8,11-tetrathiacyclotetradecane). The binding group J may be a combination of these compounds, or may have a cyclic form or chain form, or may be a large ring compound such as those known as a crown ether, cryptand, or calixarene.

The number of valences of the lanthanide ion may be 0, 1, 2, 3, or 4. When plural binding groups are connected with the lanthanide ion, these groups may be the same or different from each other. The binding style of the binding group with the lanthanide ion may be a covalent bond, an ionic bond, or a coordinate bond. When plural bonds are present, the binding styles may be the same or different.

The number of atoms, except hydrogen atoms, contained in the binding group J is preferably 1 to 60, more preferably 1 to 45, and most preferably 3 to 40.

The group represented by Met is bonded directly to the group represented by COG. The binding style may be any binding style such as a covalent bond, an ion bond, or a coordinate bond, and it is preferred that Met and COG be connected via one or more coordinate bonds.

In formula (I), COG represents a heterocyclic group bonded directly to the lanthanide ion contained in the group represented by Met. The group represented by COG is preferably a group represented by the following formula (II).

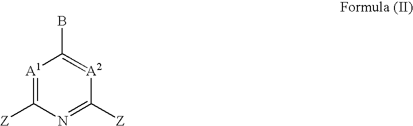

In the formula, B represents a bond by which the group represented by ChHet is bonded.

A¹ and A² each independently represent a nitrogen atom or ═C(—R¹)—. At least one of A¹ and A² preferably represents a nitrogen atom.

R¹ represents a hydrogen atom or a substituent. When R¹ represents a substituent, it preferably represents an alkyl group, an alkenyl group, an alkynyl group, an aryl group, a heterocyclic group, a silyl group, an alkoxy group, an amino group, an acylamino group, a sulfonylamino group, an acyl group, a sulfonyl group, a formyl group, an alkoxycarbonyl group, a carbamoyl group, a sulfamoyl group, a halogen atom, a cyano group, a sulfo group, or a carboxyl group, each of which may be further substituted; and more preferably an alkyl group, an alkenyl group, an alkynyl group, an aryl group, an acyl group, a sulfonyl group, an alkoxycarbonyl group, a carbamoyl group, a halogen atom, or a cyano group, each of which may be further substituted.

As to R¹, the number of atoms except hydrogen atoms is preferably 1 to 30, more preferably 1 to 20, and most preferably 1 to 10.

Z represents a group having at least one atom or atomic group bonded with the lanthanide ion contained in the group represented by Met. As such a group, preferred is a substituted alkyl group, alkenyl group, alkynyl group, aryl group, heterocyclic group, alkoxy group, amino group, acylamino group, sulfonylamino group, carbamoyloxy group, or ureido group; and more preferred is a substituted alkyl group, aryl group, heterocyclic group, alkoxy group, or amino group.

The binding style of the substituent Z and the lanthanide ion contained in Met may be any of a covalent bond, an ion bond, and a coordinate bond.

The atom or atomic group bonded with the lanthanide ion is preferably a nitrogen atom of an amine, a nitrogen atom of a nitrogen-containing heterocycle, a sulfur atom of a sulfur-containing heterocycle, an oxygen atom of an oxygen-containing heterocycle, an oxygen atom of an ether bond, a sulfur atom of a thioether bond, an oxygen atom of a carboxylic acid, an oxygen atom of 1,3-diketone, an oxygen atom and/or a nitrogen atom of an oxime, an oxygen atom and/or a nitrogen atom of a urea bond, an oxygen atom and/or a nitrogen atom of an amide bond, a sulfur atom and/or a nitrogen atom of a thiourea bond, or a nitrogen atom of an imine; and more preferably a nitrogen atom of an amine, a nitrogen atom of a nitrogen-containing heterocycle, a sulfur atom of a sulfur-containing heterocycle, an oxygen atom of an ether bond, a sulfur atom of a thioether bond, an oxygen atom of a carboxylic acid, or an oxygen atom of 1,3-diketone.

As to Z, the number of atoms excluding hydrogen atoms is preferably 1 to 60, more preferably 1 to 45, and most preferably 1 to 35.

The group represented by formula (II) is more preferably a group represented by formula (III) or (IV).

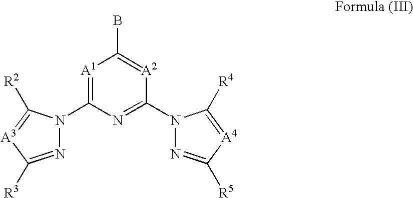

In the formula, B is a bond by which the group represented by ChHet is bonded.

A¹, A², A³, and A⁴ each independently represent a nitrogen atom or ═C(—R¹)—, in which R¹ represents a hydrogen atom or a substituent. Examples of R¹ are the same as those of the aforementioned R¹.

R², R³, R⁴, and R⁵ each independently represent a hydrogen atom or a substituent. When R² to R⁵ respectively represent a substituent, preferable examples of the substituent include an alkyl group, an alkenyl group, an alkynyl group, an aryl group, a heterocyclic group, a silyl group, an alkoxy group, an amino group, an acylamino group, a sulfonylamino group, an acyl group, a sulfonyl group, a formyl group, an alkoxycarbonyl group, a carbamoyl group, a sulfamoyl group, a halogen atom, a cyano group, a sulfo group, and a carboxyl group, each of which may be further substituted; and more preferable examples of the substituent include an alkyl group, an alkenyl group, an alkynyl group, an aryl group, an acylamino group, and a sulfonylamino group, each of which may be further substituted, and a halogen atom. The substituents described as the group represented by Z in formula (II) may also be given as more preferable examples.

As to R² to R⁵, the number of atoms excluding hydrogen atoms is preferably 1 to 60, more preferably 1 to 45, and most preferably 1 to 35.

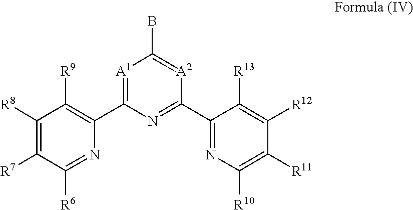

In formula, B represents a bond by which the group represented by ChHet is bonded.

A¹ and A² each independently represent a nitrogen atom or ═C(—R¹)—, in which R¹ represents a hydrogen atom or a substituent. Examples of R¹ are the same as those of the aforementioned R¹.

R⁶, R⁷, R⁸, R⁹, R¹⁰, R¹¹, R¹², and R¹³ each independently represent a hydrogen atom or a substituent. When any of R⁶, R⁷, R⁸, R⁹, R¹⁰, R¹¹, R¹², and R¹³ represent a substituent, preferable examples of the substituent include an alkyl group, an alkenyl group, an alkynyl group, an aryl group, a heterocyclic group, a silyl group, an alkoxy group, an amino group, an acylamino group, a sulfonylamino group, an acyl group, a sulfonyl group, a formyl group, an alkoxycarbonyl group, a carbamoyl group, a sulfamoyl group, a halogen atom, a cyano group, a sulfo group, and a carboxyl group, each of which may be further substituted; and more preferable examples of the substituent include an alkyl group, an alkenyl group, an alkynyl group, an aryl group, an acylamino group, and a sulfonylamino group, each of which may be further substituted, and a halogen atom. The substituents described as the group represented by Z in the formula (II) may also be given as more preferable examples.

As to R⁶, R⁷, R⁸, R⁹, R¹⁰, R¹¹, R¹², and R¹³, the number of atoms excluding hydrogen atoms is preferably 1 to 60, more preferably 1 to 45, and most preferably 1 to 35.

In the group represented by formula (II), (III), or (IV), among the nitrogen atoms contained in the heterocycle(s), a nitrogen atom(s) that has a lone-electron pair may bind to the lanthanide ion, and it is more preferred that the lone-electron pair bind to the lanthanide ion. R² to R⁵ in formula (III) and R⁶ to R¹³ in formula (IV) may have a group that binds to lanthanide ion, and, among these, R³, R⁵, R⁶ and/or R¹⁰ preferably have a group that binds to lanthanide ion. If any of these groups have a group that binds to lanthanide ion, the binding group is preferably an aryl group, a heteroaryl group, or an ethynyl group when the bond is a covalent bond; an atom having a lone-electron pair (e.g., oxygen atom, sulfur atom, nitrogen atom, phosphorus atom, or selenium atom) when the bond is a coordination bond; and a group having a negative ion such as a carboxyl anion, a sulfonamide anion, a sulfone imide anion, a phenoxide anion, or a phosphonate anion when the bond is an ionic bond.

In formula (I), ChHet represents a group containing a heterocycle. The heteroatom contained in the heterocycle which the group represented by ChHet contains is preferably a nitrogen atom, a boron atom, a sulfur atom, an oxygen atom, a phosphorous atom, or a selenium atom; and more preferably a nitrogen atom, a boron atom, a sulfur atom, or an oxygen atom. The heterocycle which the group represented by ChHet contains is most preferably a nitrogen-containing heterocycle.

The binding style of the group represented by ChHet with the group represented by COG is preferably a covalent bond, and the group represented by COG is more preferably conjugated with the group represented by ChHet by a π bond.

The group represented by ChHet is preferably a group represented by the following formula (V).

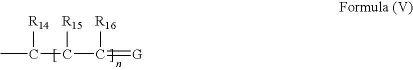

In the formula, R¹⁴, R¹⁵, and R¹⁶ each independently represent a hydrogen atom or a substituent, and R¹⁴ and R¹⁵, R¹⁵ and R¹⁶, and R¹⁴ and R¹⁶ may be respectively combined with each other to form a ring. Here, the substituent indicates one selected from an alkyl group, an aryl group, a carboamido group, a sulfonamido group, an alkylthio group, a heterocyclic group, an alkoxy group, an aryloxy group, and combinations of these groups. n denotes 0, 1, or 2. G represents an atomic group necessary to form a five- or six-membered nitrogen-containing heterocycle, wherein the nitrogen-containing heterocycle may form a condensed ring. Also, G may be combined with R⁴, R¹⁵, or R¹⁶, to form a ring.

Examples of the heterocycle preferable as G will be explained below. The following examples represent each skeleton of heterocycles and may be used as partially saturated skeletons, wherein the position of a hetero atom is optionally selected in each cyclic system and the condensed ring may be condensed at desired position. Also, the heterocycle may be one represented by a combination of these rings.

Examples of the heterocycle include pyrrole, pyrazole, imidazole, triazole, tetrazole, thiophene, furan, oxazole, thiazole, oxadiazole, thiadiazole, selenazole, pyridine, pyrimidine, pyrazine, pyridazine, triazine, tetrazine, oxazine, thiazine, oxadiazine, thiadiazine, pyrrolopyrrole, indole, pyrrolopyrazole, pyrroloimidazole, pyrrolotriazole, pyrrolotetrazole, thienopyrrole, pyrrolooxazole, pyrrolothiazole, pyrrolopyridine, pyrrolopyrimidine, pyrrolopyrazine, pyrrolopyridazine, pyrrolotriazine, pyrrolotetrazine, pyrrolooxazine, pyrrolothiazine, pyrrolothiadiazine, indazole, benzimidazole, benzotriazole, benzothiophene, benzofuran, benzoxazole, benzothiazole, benzooxadiazole, benzothiadiazole, benzoselenazole, quinoline, quinazoline, quinoxaline, phthalazine, benzotriazine, benzooxazine, benzothiazine, pyrazolopyrazole, pyrazolooxazole, pyrazolothiadiazole, pyrazolopyridine, pyrazolopyrimidine, pyrazolopyrazine, pyrazolopyridazine, pyrazolotriazine, pyrazolooxazine, pyrazolothiazine, pyrazolothiadiazine, imidazolopyrazole, pyrazolotriazole, pyrazolotetrazole, thienopyrazole, furopyrazole, pyrazolooxazole, imidazoloimidazole, imidazolotriazole, imidazolotetrazole, thienoimidazole, furoimidazole, imidazolooxazole, imidazolooxadiazole, imidazolothiadiazole, imidazoloselenazole, imidazolopyridine, imidazolopyrimidine, imidazolopyrazine, imidazolopyridazine, imidazolotriazine, imidazolooxazine, imidazolothiazine, imidazolooxadiazine, imidazolothiadiazine, triazolotriazole, thienotriazole, furotriazole, triazolooxazole, triazolothiazole, triazolooxadiazole, triazolothiadiazole, triazolopyridine, triazolopyrimidine, triazolopyrazine, triazolopyridazine, triazolotriazine, triazolooxazine, triazolothiazine, triazolooxadiazine, triazolothiadiazine, tetrazolooxazole, tetrazolothiazole, tetrazolopyridine, tetrazolopyrimidine, tetrazolopyrazine, tetrazolopyridazine, tetrazolooxazine, tetrazolothiazine, thienothiophene, thienofuran, thienooxazole, thienothiazole, thienooxadiazole, thienothiadiazole, thienoselenazole, thienopyridine, thienopyrimidine, thienopyrazine, thienopyridazine, thienotriazine, thienotetrazole, thienoxazine, thienothiazine, thienooxadiazine, thienothiadiazine, furooxazole, furothiazole, furooxadiazole, furothiadiazole, furopyridine, furopyrimidine, furopyrazine, furopyridazine, furotriazine, furooxazine, furothiazine, oxazolooxazole, thiazolooxazole, oxazolooxadiazole, oxazolothiadiazole, oxazolopyridine, oxazolopyrimidine, oxazolopyrazine, oxazolopyridazine, oxazolotriazine, oxazolooxazine, oxazolothiazine, oxazolooxadiazine, oxazolothiadiazine, thiazolothiazole, thiazolooxadiazole, thiazoloselenazole, thiazolopyridine, thiazolopyrimidine, thiazolopyrazine, thiazolopyridazine, thiazolotriazine, thiazolooxazine, thiazolothiazine, thiazolooxadiazine, thiazolothiadiazine, dithiol, dioxole, benzodithiol, and benzodioxole.

As to ChHet, the number of atoms excluding hydrogen atoms is preferably 6 to 70, more preferably 6 to 55, and most preferably 10 to 45.

Specific examples (which may have a substituent) of the basic skeleton of the group represented by ChHet will be given below. However, the scope of the present invention is not limited by these examples. In the following examples of the group represented by ChHet, R represents a group except for hydrogen atom, the waved-line bond indicates the resultant compound being any one or a mixture of geometrical isomers, and # represents the site where ChHet binds with the group represented by COG.

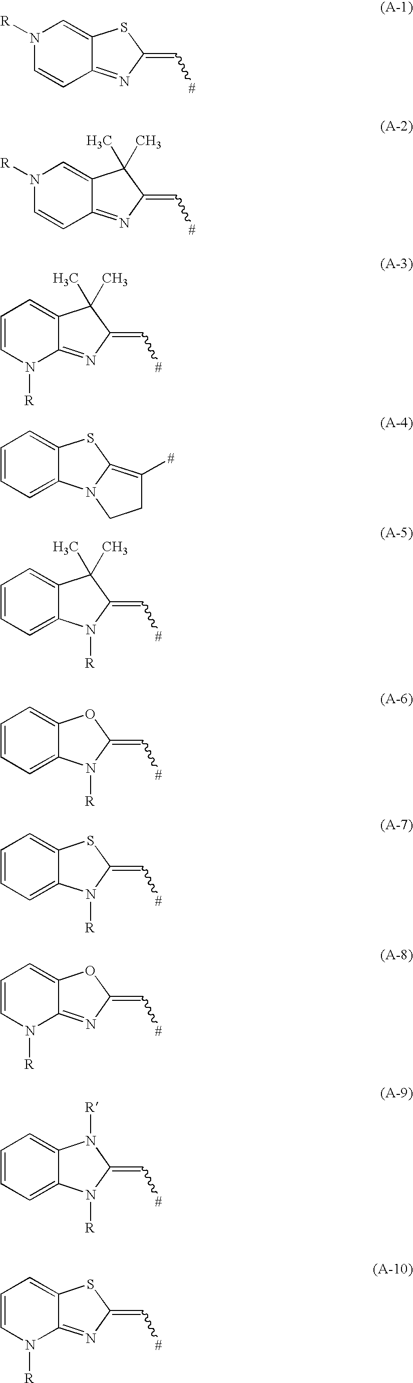

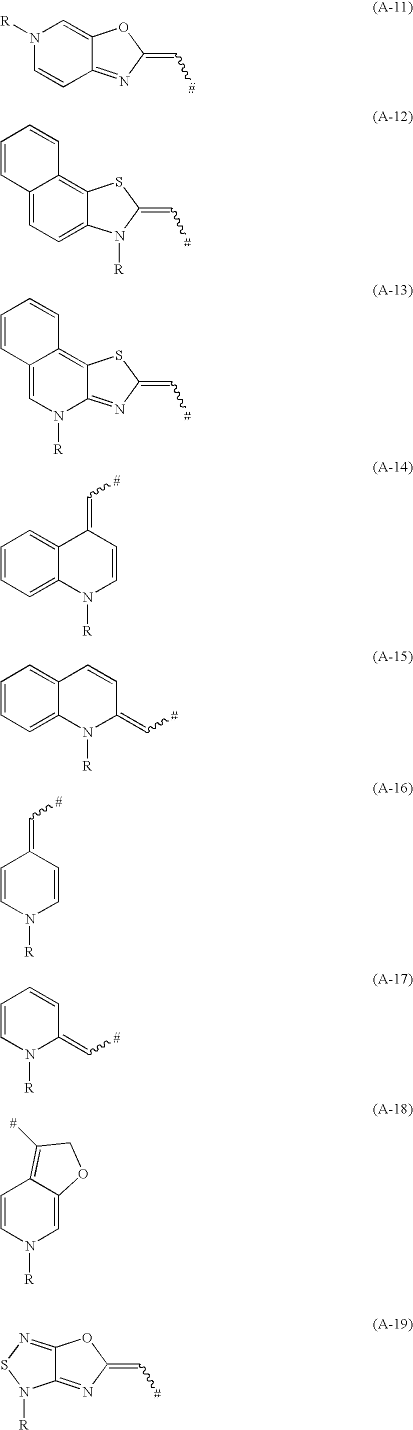

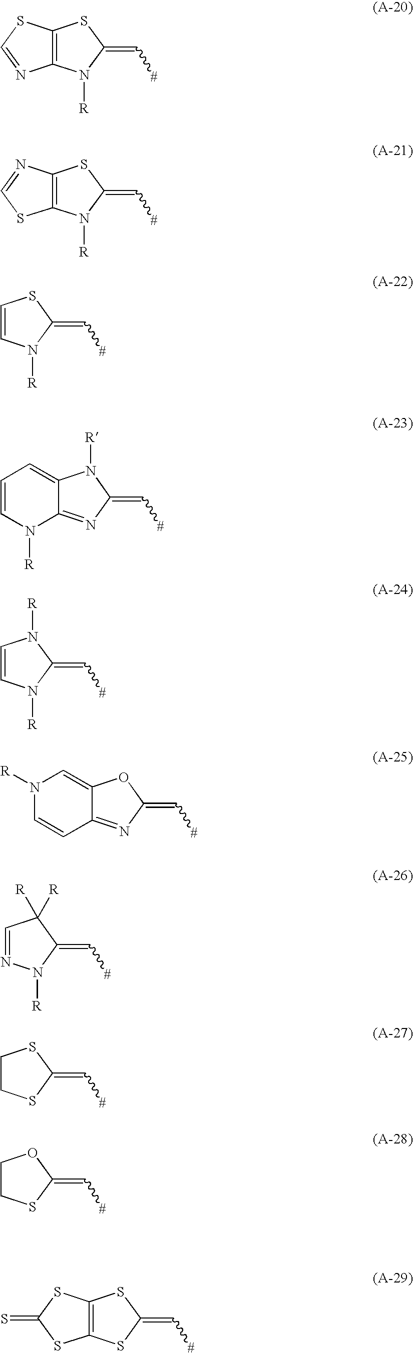

Next, specific examples of the compounds of the present invention will be given below to explain the present invention in more detail. However, the scope of the present invention is not limited by these examples. In these specific examples, M represents a lanthanide ion.

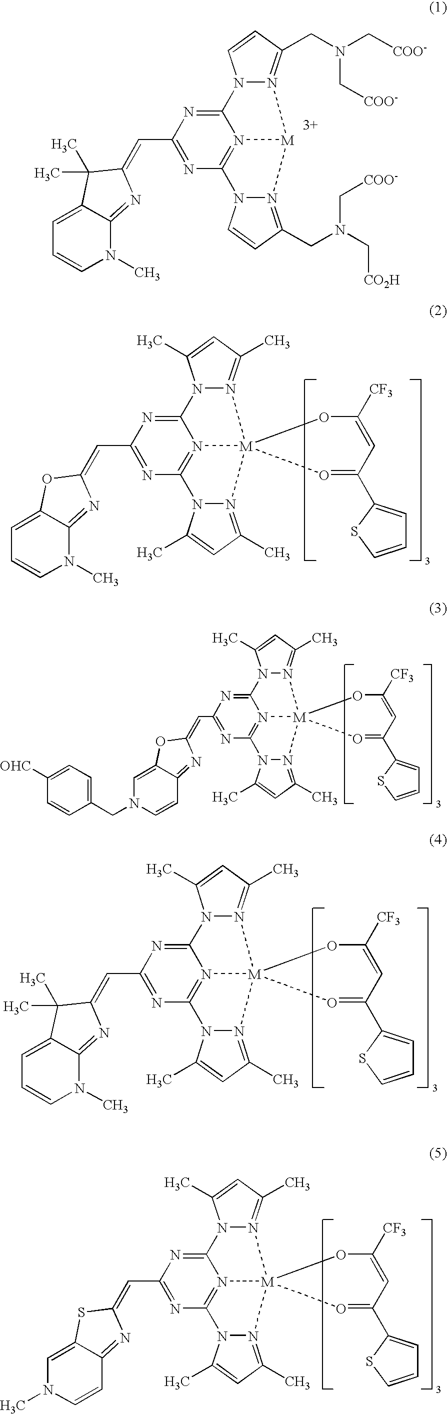

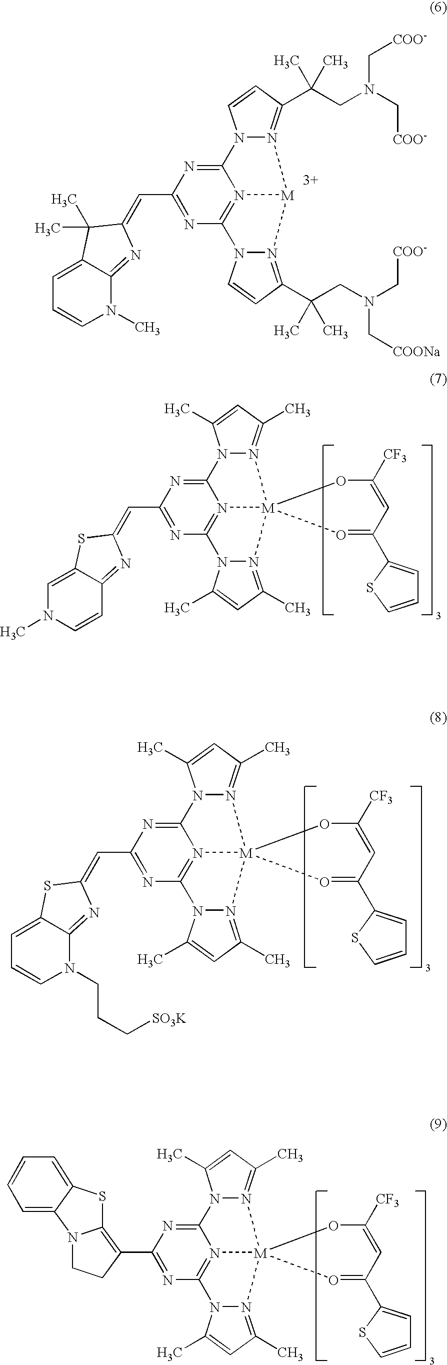

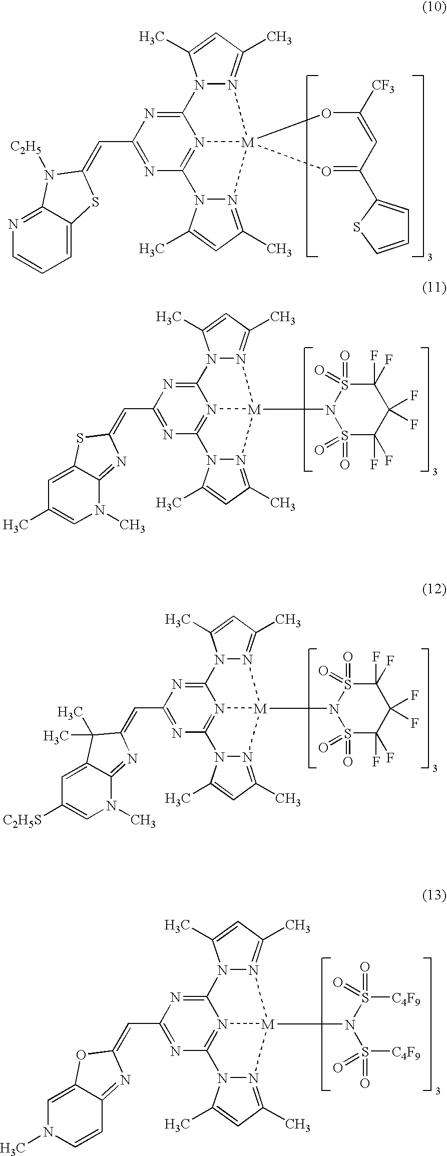

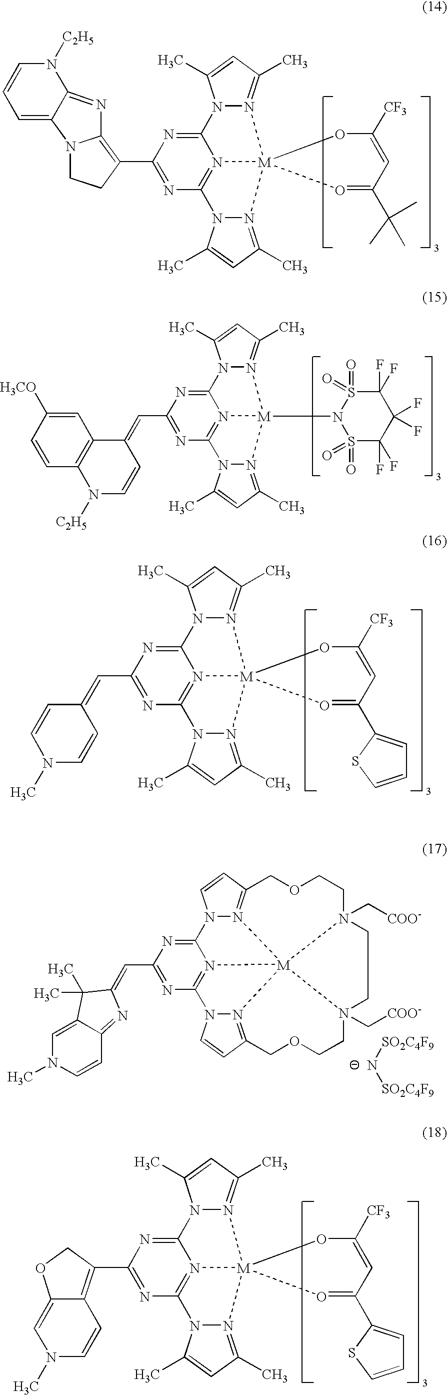

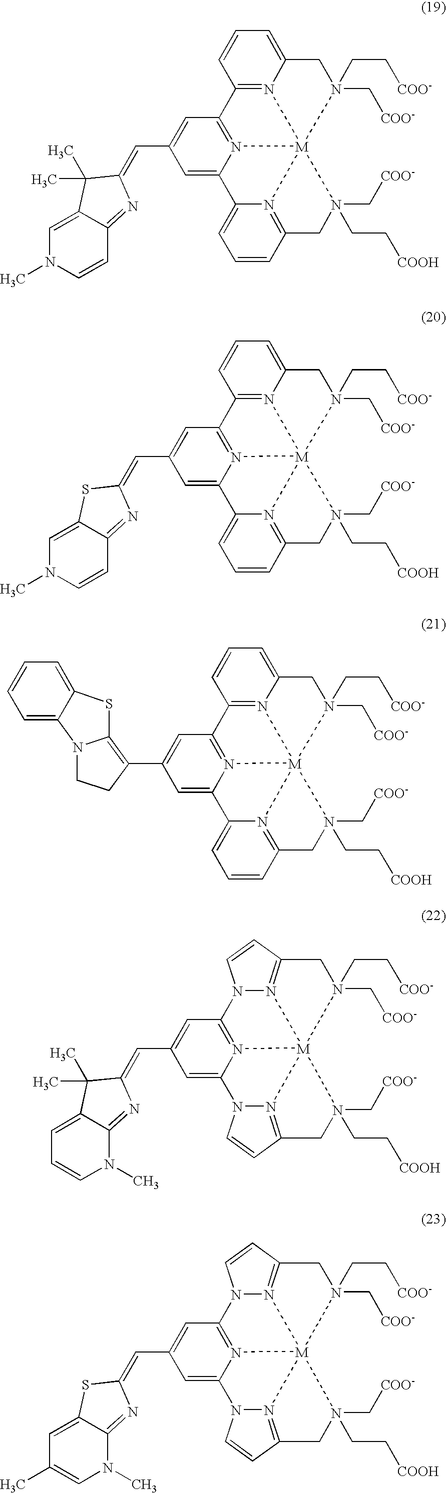

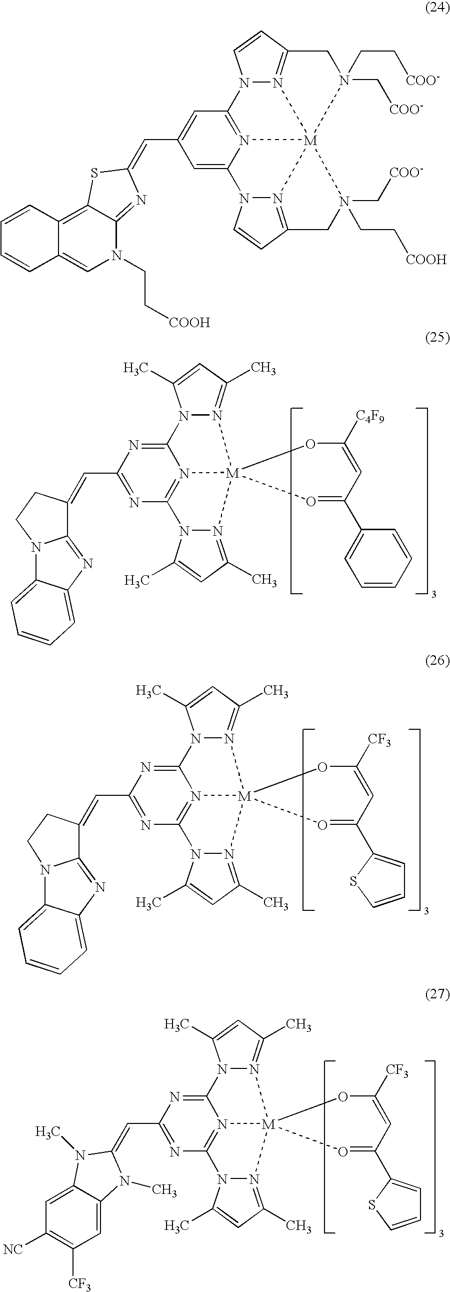

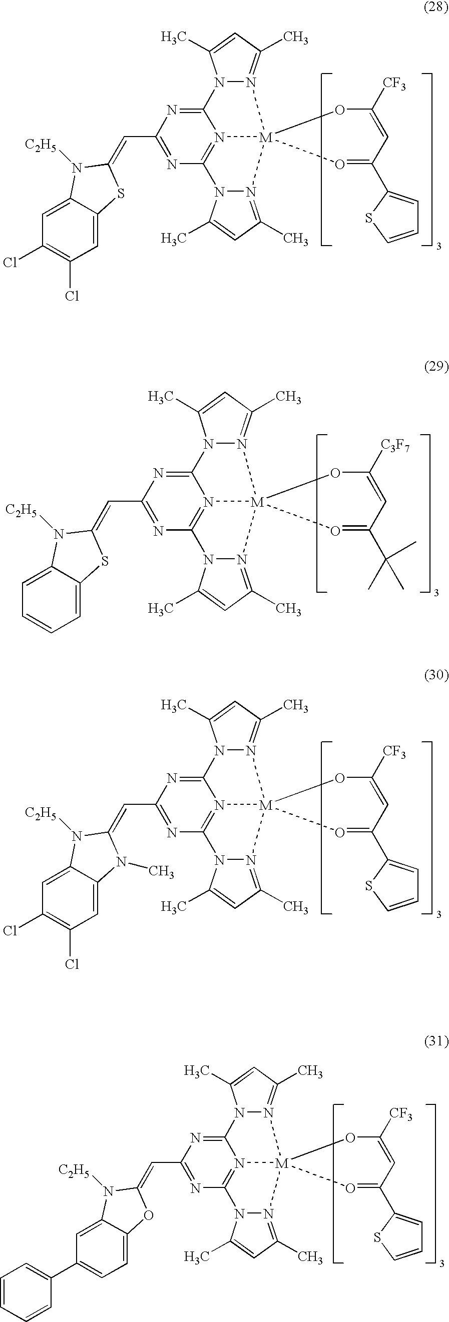

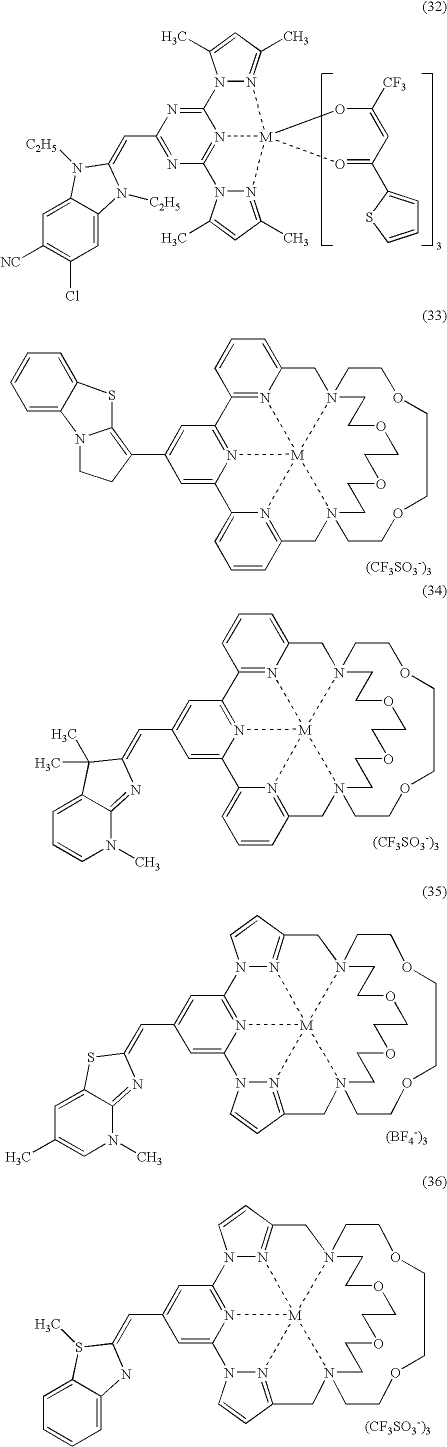

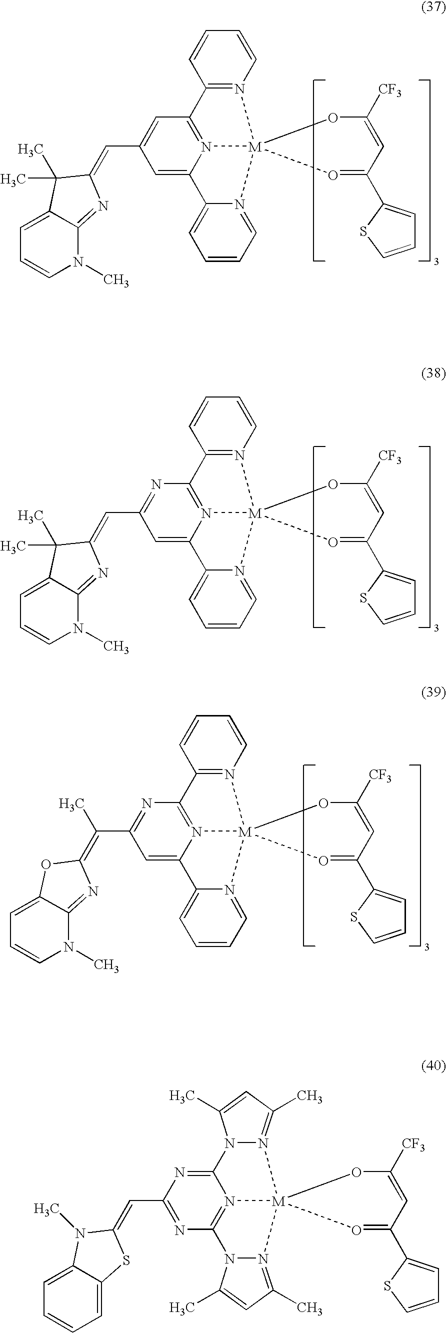

Next, a process for producing the compound represented by formula (I) of the present invention will be explained.

The compound represented by formula (I) of the present invention is usually synthesized by reacting Met with COG-ChHet. First, COG-ChHet part can be usually synthesized by coupling COG part with ChHet. A lanthanide ligand is formed and then led to a lanthanide complex. The synthesis of the compound of the present invention, including steps other than the above coupling reaction, may be accomplished with reference to methods as described in, for example, “Angewandte Chemie, International Edition,” (2004), Vol. 43, p. 5009 and JP-A-7-267927. The lanthanide ligand according to the present invention can be prepared with reference to various literatures concerning dye synthesis, from the viewpoint of the ligand being a dye having an absorption in the wavelength range of visible light or the range close to it. Production methods of the dye part are described, for example, in “Dictionary of Color Chemicals (General dictionary of functional dyes)”, Mitsuhiko Tobita, published by Soc. Synthetic Organic Chemistry; “Dye Handbook (New Edition)”, published by Soc. Synthetic Organic Chemistry (1974); “Introduction to Photographic Dyes”, Tsuneyuki Kimura, published by Kogyo Tosho (1997); “Chemistry of Heterocyclic Compounds, Vol. 18: Cyanine Dyes and Related Compounds”; F. M. Hamer, published by Wiley; and the references cited in these. Production methods of the part that involves in bond formation with lanthanide ion are described, for example, in “Chemistry of Crown Ethers and Cryptands”, Reed Izatt, published by Kagaku-dojin (Kyoto) (1979); “New Trends in Synthesis of Medium- and Macro-cyclic Natural Products”, Chemical Society of Japan Ed., published by Center for Academic Publications Japan (1981); “Metal Chelate Compounds”, A. E. Martell, and Melv Calvin, published by Kyoritsu Shuppan (1960); “Chelate Chemistry”, Keihei Ueno, published by Nankodo; and “New Experimental Chemistry (5 Ed.) 21”, Chemical Society of Japan Ed., published by Maruzen (2004), and the references cited in these. Production and handling methods of common lanthanide compounds are described in detail, for example, in chapters 14 to 18 of “Science of Rare Earth Elements”, Ginya Adachi ed., published by Kagaku-Dojin Publishing, and the references cited therein. It is possible to produce a further wider range of compounds with reference to the methods in the aforementioned literatures and the working examples which will be described later. As to the bond forming reaction between the group B in the compound represented by formula (II) and the rest of the compound (hereinafter, referred to as a group C), roughly two kinds of binding methods can be mentioned. One is the case where the group C has a group allowing nucleophilic substitution (a leaving group), and the group B has an enamine structure, and these groups react with each other in a nucleophilic substitution reaction. The other is the case where the group C has a nucleophilic carbon anion, and the group B has a group allowing nucleophilic substitution (a leaving group), and these groups react with each other in a nucleophilic substitution reaction. Both methods can be used favorably for production of the compound according to the present invention. For production of the compound represented by formula (III), generally employed are a method of forming a tricyclic compound in a substitution reaction of a halogenated azine and an azole, and allowing it to react with a heterocyclic compound having an enamine structure (generally, called a methylene base), and a method of reacting a halogenated azine with a heterocyclic compound having an enamine structure and then performing a substitution reaction with an azole; and the compound according to the present invention is favorably prepared by either of them. Preparation of the Compound Represented by Formula (Iv) is the Same in Basic Strategy as that for the compound represented by formula (III), but different in that it is necessary to form carbon-carbon bonds between the two pyridine rings and the central azine ring. Various carbon-carbon bond-forming reactions may be used for bond formation, but, for example, carbon-carbon bond-forming reactions, such as Grignard reaction and palladium-catalyzed reaction (e.g., Suzuki coupling reaction) are used favorably.

When the compound represented by formula (I) of the present invention is used, it can be dissolved in various solvents. The solvent may be selected from water, less polar organic solvents, such as alcohols, hexanes, toluenes, esters, ethers, and amines; polar organic solvents, such as nitriles, amides, sulfones, and sulfoxides; and halogen type solvents, such as dichloromethane, chloroform, and fluorinated hydrocarbons, according to the need. Mixtures of these solvents may also be likewise used.

The compound of the present invention may be mixed in a binder upon use. Examples of the binder which may be used include natural polymers, such as gelatin and carrageenan, and synthetic polymers, such as a polymethacrylic acid, polyacrylic acid, polystyrene, polyvinyl alcohol, and polyethylene oxide. Also, various resists may be used for the purpose of patterning. When the compound of the present invention is mixed in the binder, it may be mixed as a solution in the above solvent or kneaded directly with the binder.

As the excitation wavelength, it is possible to employ a wavelength widely ranging from the ultraviolet region to the visible region. Visible lights and wavelengths close to visible lights are preferable as the excitation wavelength. Although the range of the excitation wavelength differs depending on use, preferable examples of the excitation light source include light emitting diodes, semiconductor lasers, sunlight, usual room lamps, liquid-crystal-display back lights, organic EL emission, inorganic EL emission, and halogen lamps. When these are used as light sources, it is preferred that the excitation maximum be at a wavelength range from 360 nm to 700 nm, preferably from 360 nm to 600 nm, and most preferably 390 nm to 550 nm. It is preferable to adopt two-photon excitation. In this case, it is possible to use excitation light having a wavelength twice the above preferable excitation wavelength. Alternatively, a so-called upconversion method, i.e., a method of forming a higher excited state by using two excitation lights that may be different in wavelength, may also be used.

As an excitation method, either continuous light radiation or pulsatile excitation may be adopted.

Another embodiment of the present invention is a ligand dye represented by the above formula (II-b), (III-b), or (IV-b). In formula (II-b), (III-b), or (IV-b), B′ represents a group containing a heterocycle, and the heterocycle is the same as the heterocycle contained in ChHet of formula (I), and the preferable ranges thereof are the same. In the formula, each of A¹ to A⁴ and R¹ to R¹³ is the same as that in formula (II) to (IV). In addition, in the formula, Z′ represents a group having at least one atom or atom group which is capable of binding to a lanthanide ion of the group containing lanthanide ion.

The “ligand dye” of the present invention is a dye that absorbs a light having a wavelength in the visible light range or the range close to it, and has a potential to bind to a lanthanide ion, and preferably has a structure corresponding to the COG-ChHet part of formula (I).

For example, when the bond between COG and Met in the compound represented by formula (I) is a covalent bond, the corresponding ligand dye according to the present invention is a compound having a structure corresponding to the COG-ChHet part in the compound represented by formula (I) of which the lanthanide atom is replaced with hydrogen atom. Alternatively, when the bond between COG and Met is a coordination bond, i.e., when a lone-electron pair of nitrogen atom, oxygen atom, sulfur atom, or the like is bound to the lanthanide ion, the corresponding ligand dye according to the present invention is a compound having a structure corresponding to the COG-ChHet part containing a lone-electron pair. Alternatively, when the bond between COG and Met is an ionic bond, the corresponding ligand dye is a compound having a structure corresponding to the COG-ChHet part of which the lanthanide ion is replaced with an ion other than hydrogen or lanthanide ions (e.g., ammonium ion, Group-1 element ion, Group-2 element ion, sulfonium ion, or phosphonium ion).

The present invention will be described in more detail based on the following examples, but the invention is not intended to be limited thereto.

### EXAMPLES

### Example 1

### Production of Ligand Part of Exemplified Compound (2)

(1-1) Synthesis of 2-methyloxazolo[4,5-b]pyridine

80 mL of ethyl orthoacetate was added to 15 g (136 mmol) of 2-amino-3-hydroxypyridine, followed by addition of p-toluenesulfonic acid in a catalytic amount, and the mixture was reacted at 120° C. for 4 hours. After the reaction solution was cooled, triethylamine was added to the solution, to neutralize p-toluenesulfonic acid. Then, the solution was subjected to distillation under reduced pressure by using an evaporator, and then purified by silica gel column chromatography.

Amount of the product: 12.0 g, Yield: 65.8%.

(1-2) Synthesis of 2,4-dimethyloxazolo[4,5-b]pyridinium iodide

10 g (74.6 mmol) of the compound synthesized in the above (1-1) was suspended in 70 mL of acetone, followed by addition of 10 mL of methyl iodide, and the mixture was refluxed under heating for 5 hours. After the reaction solution was cooled, the precipitated crystals were collected by filtration, washed with acetone, and dried.

Amount of the product: 16.5 g, Yield: 80.1%.

### (1-3) Production of the Ligand Part of Exemplified Compound (2)

2.8 g of the quaternary salt synthesized in the above (1-2) and 1.9 g of cyanur chloride were suspended in 100 mL of dehydrated tetrahydrofuran, and 2 mL of N-ethyldiisopropylamine was slowly added dropwise to the mixture under water-cooling. After the mixture was reacted for one hour, 30 mL of dimethylacetamide and 10 g of 3,5-dimethylpyrazole were added, and then tetrahydrofuran was removed by distillation under reduced pressure. The resulting mixture was heated at 80° C. for 2 hours and then cooled, followed by purification by silica gel column chromatography. Furthermore, the resulting solid was dissolved in dimethylformamide, and ethyl acetate was added to the mixture, to carry out precipitation.

Amount of the product: 0.53 g, Yield: 12.8%.

Material Data

Mass spectrum: 416.2 (M+H)⁺

NMR spectrum (heavy DMSO): 7.83 (1H, t), 7.5-7.6 (1H, d (two types)), 6.84-6.94 (1H, t (two types)), 6.15-6.2 (2H, s (two types)), 5.34 (1H, s (two types)), 3.9-4.0 (3H, s (two types)), 2.7-2.9 (6H, s (two types)), 2.20 (6H, s)

The presence of two types in the above NMR spectrum was because the olefin part was a mixture of E and Z isomers (about 1:1).

### Example 2

### Production of Exemplified Compound (4)

(2-1) Synthesis of 2,3,3-trimethyl-3H-pyrrolo[2,3-b]pyridine

20 mL of 3-methyl-2-butanone was added to 10 g of 2-hydrazinopyridine, and the mixture was heated at 80° C. for one hour. The produced water and excess 3-methyl-2-butanone were removed by distillation under reduced pressure. Then, 1 g of zinc chloride was added to the residue, followed by heating at 200° C. for 3 hours. The resulting mixture was distilled under reduced pressure, and the residue was recrystallized from hexane, to obtain the target product.

Amount of the product: 4.6 g, Yield: 31.0%.

(2-2) Synthesis of 2,3,3,7-tetramethyl-3H-pyrrolo[2,3-b]pyridinium

4 g (25 mmol) of the compound obtained in the above (2-1) was dissolved in 40 ml of acetone, and 4 mL of methyl iodide was added thereto. The mixture was refluxed under heating for one hour. After the reaction solution was cooled, the precipitated crystals were collected by filtration, washed with acetone, and dried, to obtain the target product.

Amount of the product: 6.5 g, Yield: 86.0%.

### (2-3) Production of the Ligand Part of Exemplified Compound (4)

30 mL of water and 50 mL of toluene were added to 5 g (16.5 mmol) of the quaternary salt synthesized in the above (2-2), and the mixture was stirred under water-cooling. 3 g of potassium hydroxide was added to the mixture, followed by stirring for 20 minutes, and the solution was separated, to take out the organic phase. This organic phase was dried over anhydrous magnesium sulfate, and toluene was removed by distillation under reduced pressure. 35 mL of dimethylacetamide was added to the residue, and 2.7 g of cyanur chloride was then added under ice-cooling, and the mixture was reacted for one hour. 12 g of 3,5-dimethylpyrazole was added to the reaction solution, followed by reaction at 80° C. for 3 hours.

When 100 mL of ethyl acetate was added to the reaction solution and the mixture was cooled, crystals were precipitated. These crystals were collected by filtration, washed with ethyl acetate, dissolved in dimethylformamide, and then added with ethyl acetate, to crystallize. The obtained crystals were collected by filtration and dried, to obtain the target product.

Amount of the product: 1.3 g, Yield: 17.8%.

Material Data

Mass spectrum: 442.1 (M+H)+

NMR spectrum (heavy chloroform): 7.11 (1H, d), 7.03 (1H, d), 6.35 (1H, t), 6.03 (2H, s), 5.75 (1H, s), 3.94 (3H, s), 2.85 (6H, s), 2.32 (6H, s), 1.38 (6H, s)

### (2-4) Production of Exemplified Compound (4)

According to the method described in “Angewandte Chemie, International Edition,” (2004), Vol. 43, p. 5009, equimolar amounts of the ligand part of Exemplified compound (4) synthesized in the above (2-3) and the lanthanide part were dissolved in dehydrated tetrahydrofuran, and then reacted to form a complex, followed by removal of solvents by distillation. Thereafter, the residue was dissolved in dehydrated diethyl ether, and n-hexane was added to collect the precipitated solid by filtration. The collected solid was washed with hexane and dried, to obtain Exemplified compound (4).

Material Data

NMR spectrum (heavy chloroform): 24.6 (3H, s), 11.8 (1H, s), 7.08 (1H, d), 7.00 (1H, d), 6.83 (3H, s), 6.39 (1H, dd), 6.07 (3H, s), 5.14 (3H, s), 4.72 (6H, s), 4.14 (3H, s), 1.01 (6H, s)

### Example 3

### Production of Ligand Part of Exemplified Compound (9)

(3-1) Production of the Ligand Part of the Exemplified Compound (9)

2.56 g (10 mmol) of 2,3-dihydro-1H-benzo[d]pyrrolo[2,1-b]thiazolium bromide (synthesized with reference to the publication of JP-A-40-13759) and 1.9 g of cyanur chloride were suspended in 90 mL of dehydrated tetrahydrofuran, followed by slow, dropwise addition of 4 mL of N-ethyldiisopropylamine at room temperature. The mixture was reacted for 1 hour, and 30 mL of dimethylacetamide and 15 g of 3,5-dimethylpyrazole were then added to the reaction mixture. The mixture was subjected to distillation under reduced pressure, to remove tetrahydrofuran. The residue was heated at 80° C. for 2 hours, cooled, and then purified by silica gel column chromatography. Further, the obtained solid was dissolved in dimethylformamide, and ethyl acetate was added to the solid, to crystallize.

Amount of the product: 0.70 g, Yield: 15.8%.

Material Data

Mass spectrum: 443.2 (M+H)⁺, 465.1 (M+Na)⁺

NMR spectrum (heavy DMSO): 7.83 (1H, d), 7.40 (1H, t), 7.24 (1H, d), 7.15 (1H, t), 6.19 (2H, s), 4.37 (2H, t), 3.44 (2H, t), 2.73 (3H, s), 2.67 (3H, s), 2.26 (3H, s), 2.22 (3H, s)

### Example 4

### Production of Exemplified Compound (30)

(4-1) Preparation of 2,4,6-tris(3,5-dimethylpyrazol-1-yl)-1,3,5-triazine

18.4 g of cyanuric chloride was dissolved in 100 mL of dimethylacetamide, and 69.2 g of 3,5-dimethylpyrazole was added thereto at room temperature. The solution was allowed to react at a reaction temperature of 80° C. for two hours.

After cooling, the reaction solution was poured into water, and the precipitated crystal was filtered, and then recrystallized from dimethylformamide. Amount of the product: 21.0 g, Yield: 57.9%. NMR spectrum data (heavy chloroform): 6.11 (3H, s), 2.81 (9H, s), 2.33 (9H, s)

### (4-2) Production of the Ligand Part of Exemplified Compound (30)

3.93 g of 5,6-dichloro-1,2-dimethyl-3-ethyl-1H-benzimidazolium trifluoromethanesulfonate was dissolved in 50 mL of dimethylsulfoxide; and then 3.63 g of the 2,4,6-tris(3,5-dimethylpyrazol-1-yl)-1,3,5-triazine prepared in the above (4-1) was added thereto. 3 mL of 1,8-diazabicyclo[5.4.0]-7-undecene was added to the mixture, and the solution was allowed to react at 70° C. for 1 hour. After cooling, water was added to the reaction solution, and the precipitated crystal was filtered. The crystal was purified by silica gel column chromatography, the crystal obtained was dissolved in dimethylformamide, and the solution was precipitated by addition of ethyl acetate. The crystal was filtered under reduced pressure, washed with a mixed solvent of hexane and ethyl acetate, and dried, to give a desired product. Amount of the product: 2.9 g, Yield: 56.8%.

NMR spectrum data (heavy chloroform): 7.30 (1H, s), 7.20 (1H, s), 6.01 (2H, s), 5.22 (1H, s), 4.11 (2H, q), 3.83 (3H, s), 2.67 (6H, s), 2.33 (6H, s), 1.34 (3H, t)

### (4-3) Production of Exemplified Compound (30)

Exemplified compound (30) was obtained in the same manner as described in the above (2-4) in Example 2.

NMR spectrum data (heavy chloroform): 24.1 (3H, bs), 11.6 (2H, s), 7.32 (1H, s), 7.14 (1H, s), 6.87 (3H, d), 6.13 (3H, dd), 5.35 (3H, d), 4.02 (6H, bs), 3.76 (1H, s), 3.57 (2H, q), 2.86 (3H, s), 1.08 (3H, bs), 0.77 (3H, t), 0.43 (3H, bs)

### Example 5

### Production of Exemplified Compound (32)

### (5-1) Production of the Ligand Part of Exemplified Compound (32)

419 mg of 6-chloro-5-cyano-1,3-diethyl-2-methyl-1H-benzimidazolium p-toluene sulfonate and 363 mg of the 2,4,6-tris(3,5-dimethylpyrazol-1-yl)-1,3,5-triazine prepared in (4-1) of Example 4 were suspended in 8 mL of dimethylsulfoxide; 0.5 mL of tetramethylguanidine was added; and the mixture was allowed to react at 80° C. for 30 minutes.

After cooling, water was added to the reaction solution, and the precipitated crystal was filtered under reduced pressure. The crystal obtained was purified by silica gel column chromatography. The crystal was recrystallized from a mixed solvent of methanol and ethyl acetate, to give a desired product.

Amount of the product: 287 mg, Yield: 55.7%.

NMR spectrum data (heavy chloroform): 7.34 (1H, s), 7.21 (1H, s), 6.04 (2H, s), 5.31 (1H, s), 4.53 (2H; q), 4.39 (2H, q), 2.70 (6H, s), 2.33 (6H, s), 1.31 (3H, t), 1.28 (3H, t)

### (5-2) Production of Exemplified Compound (32)

Exemplified compound (32) was obtained in the same manner as the method described in (2-4) in Example 2, except that the ligand part of Exemplified compound (32) prepared in the above (5-1) was used.

NMR spectrum data (heavy chloroform): 23.95 (3H, bs), 11.63 (2H, s), 7.34 (1H, s), 7.25 (1H, s), 6.89 (3H, d), 6.15 (3H, dd), 5.33 (3H, d), 4.17 (6H, s), 3.97 (1H, s), 3.72-3.68 (4H, m), 1.21 (3H, bs), 0.64 (3H, t), 0.56 (3H, t), 0.36 (3H, bs)

### Example 6

### Production of Exemplified Compound (36)

(6-1) Preparation of 2-chloro-4,6-bis(3,5-dimethylpyrazol-1-yl)-1,3,5-triazine

36.8 g of cyanuric chloride was dissolved in 250 mL of acetone, and 76.9 g of 3,5-dimethylpyrazole was added thereto in five portions, while the solution was cooled in water. The mixture was then heated under reflux for two hours, cooled to 35° C., and filtered under reduced pressure. The filtrate was cooled to 0° C., and the precipitated crystal was filtered under reduced pressure, to give a desired product. Amount of the product: 25.5 g, Yield: 42.0%.

NMR spectrum data (heavy chloroform): 6.11 (2H, s), 2.76 (6H, s), 2.32 (6H, s)

### (6-2) Production of the Ligand Part of Exemplified Compound (36)

291 mg of 2,3-dimethylthieno[2,3-d]thiazolium iodide and 310 mg of the 2-chloro-4,6-bis(3,5-dimethylpyrazol-1-yl)-1,3,5-triazine prepared in (6-1) were dissolved in 5 mL of dimethylsulfoxide; 0.5 mL of triethylamine was added thereto; and the mixture was allowed to react at 30° C. for two hours. After cooling, a solid matter precipitated by addition of water was collected by filtration, and purified by silica gel column chromatography. The solid matter obtained was recrystallized from ethyl acetate, to give a desired product. Amount of the product: 88 mg, Yield: 20.2%.

NMR spectrum data (heavy chloroform): 7.05 (1H, d), 6.97 (1H, d), 6.06 (1H, s), 6.03 (1H, s), 6.01 (1H, s), 3.62 (3H, s), 2.73 (3H, s), 2.70 (3H, s), 2.37 (3H, s), 2.33 (3H, s)

### (6-3) Production of Exemplified Compound (36)

According to the method described in “Angewandte Chemie, International Edition,” (2004), Vol. 43, p. 5009, equimolar amounts of the ligand part of Exemplified compound (36) synthesized in the above (6-2) and the lanthanide part were dissolved in dehydrated tetrahydrofuran, and then reacted to form a complex, followed by removal of solvents by distillation. Thereafter, the residue was dissolved in dehydrated diethyl ether, and n-hexane was added to collect the precipitated solid by filtration. The collected solid was washed with hexane and dried, to obtain Exemplified compound (36).

NMR spectrum data (heavy chloroform): 23.8-23.7 (3H, bs), 11.7 (1H, s), 11.5 (1H, s), 7.20 (1H, d), 7.00 (1H, d), 6.97 (3H, d), 6.12 (3H, dd), 5.30 (3H, d), 4.62 (1H, s), 4.44 (3H, s), 4.23 (3H, s), 3.29 (3H, s), 1.26 (3H, s), 0.31 (3H, s)

### Example 7

### Production of Exemplified Compound (40)

### (7-1) Production of Exemplified Compound (40)

The ligand part of Exemplified compound (40) was prepared by using 2,3-dimethyl benzothiazolium p-toluenesulfonate and the 2-chloro-4,6-bis(3,5-dimethylpyrazol-1-yl)-1,3,5-triazine prepared in (6-1) of Example 6, in the same manner to the method shown in (6-2) of Example 6, and Exemplified compound (40) was obtained in the same manner to the method shown in (2-4) of Example 2. NMR spectrum data (heavy chloroform): 24.0 (3H, bs), 11.8 (1H, bs), 11.7 (1H, bs), 7.75 (1H, d), 7.3-7.2 (2H, m), 6.90 (1H, d), 6.86 (3H, d), 6.12 (3H, dd), 5.28 (3H, d), 4.97 (1H, s), 4.49 (3H, bs), 4.31 (3H, bs), 3.82 (2H, q), 1.26 (3H, s), 1.08 (3H, t), 0.24 (3H, bs)

### Example 8

### Evaluation of Luminous Property

0.01 mmol of the compound of the present invention and 50 mg of polymethylmethacrylate

(manufactured by Wako Pure Chemical Industries, Ltd.) were dissolved in chloroform, to prepare a volume of 10 mL, which was named Solution A.

A 0.7-mm-thick glass plate was coated with a red transfer (trade name, manufactured by Fuji Photo Film Co., Ltd.), to make Filter B.

A filter was prepared in the same manner as Filter B, except for coating a green filter, and which was named as Filter C.

Solution A was applied to each of Filters B and C on the side coated with the transfer, in a thickness of 3.2 μm, followed by drying in air. The one obtained from Filter B was named Filter D, and the one obtained from Filter C was named Filter E.

These Filters D and E were respectively irradiated with light from a blue LED (manufactured by Nichia Corporation, 465 to 470 nm emission), perpendicularly, from the coated surface side, to detect the wave-converted light from the opposite side. As to the measurement, RF5300PC (trade name), manufactured by Shimadzu Corporation, was used to measure the luminescence of the light. For comparison, a comparative compound 1 (described in “Angewandte Chemie, International Edition,” (2004), Vol. 43, p. 5009), and a comparative compound 2 (described in “Monthly Publication, Material Integration,” (K.K.) TIC, Vol. 17, No. 3, March (2004)) were used, and each relative value of the luminous intensities was determined, taking the luminous intensities of the converted light of Comparative Compound 1 as 100. The results are shown in Table 1.

TABLE 1

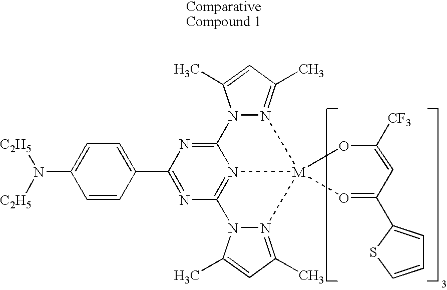

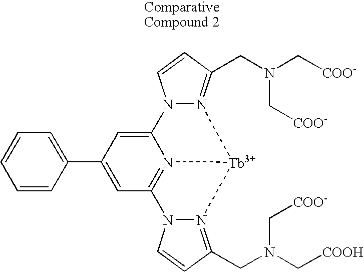

| Compound | M (lanthanide ion) | Filter D | Filter E |
|---|---|---|---|
| Blank (PMMA only) | — | 1 | 3 |
| Comparative compound 1 | Eu | 100 | — |
| Comparative compound 1 | Tb | — | 100 |
| Comparative compound 2 | Tb | — | 3 |
| Exemplified compound (2) | Eu | 180 | — |
| Exemplified compound (2) | Tb | — | 124 |
| Exemplified compound (4) | Eu | 435 | — |
| Exemplified compound (4) | Tb | — | 199 |
| Exemplified compound (5) | Eu | 322 | — |
| Exemplified compound (9) | Eu | 251 | — |
| Exemplified compound (9) | Tb | — | 188 |
| Exemplified compound (11) | Eu | 310 | — |
| Exemplified compound (15) | Eu | 138 | — |
| Exemplified comopund (29) | Eu | 303 | — |

It can be understood from the results shown in Table 1 that the comparative compounds exhibited emissions having only insufficient intensity by the blue LED (about 470 nm), which was a common light source, whereas the compounds of the present invention were excited by visible light to exhibit strong emissions. It was shown that the compound of the present invention could be used for color conversion use.

### INDUSTRIAL APPLICABILITY

The compound of the present invention may be preferably applied in various fields: the fields of marking and detection of trace components; flat panel displays, such as liquid crystal displays, and organic EL displays; the field of illumination materials; and the clothing and fashion fields.

Further, the ligand dyes of the present invention may be preferably used in the fields of trace-component detection, fluorescence ink, and others.

Having described our invention as related to the present embodiments, it is our intention that the invention not be limited by any of the details of the description, unless otherwise specified, but rather be construed broadly within its spirit and scope as set out in the accompanying claims.

1. A luminous compound represented by the following formula (I):
Met-COG-ChHet Formula (I)
wherein Met represents a group containing a lanthanide ion, COG represents a heterocyclic group bonded directly to the lanthanide ion contained in the group represented by Met, and ChHet represents a group having a heterocycle.

2. The luminous compound as claimed in claim 1, wherein the group represented by COG in formula (I) is a group represented by the following formula (II): 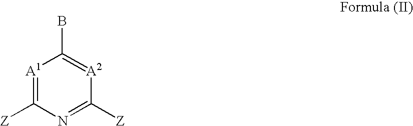
wherein B represents a bond bonded to the group represented by ChHet; A¹ and A² each independently represent a nitrogen atom or ═C(—R¹)—, in which R¹ represents a hydrogen atom or a substituent; and Z represents a group having at least one atom or atomic group bonded to the lanthanide ion contained in the group represented by Met.

3. The luminous compound as claimed in claim 2, wherein the group represented by the above formula (II) is a group represented by the following formula (III) or (IV): 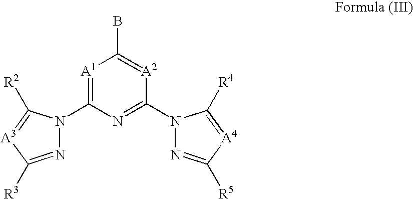
wherein B represents a bond bonded to the group represented by ChHet; A¹, A², A³, and A⁴ each independently represent a nitrogen atom or ═C(—R¹)—, in which R¹ represents a hydrogen atom or a substituent; and R², R³, R⁴, and R⁵ each independently represent a hydrogen atom or a substituent; 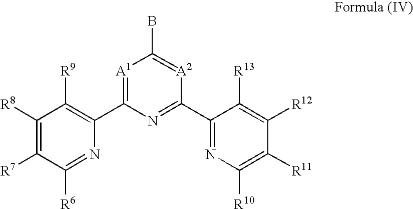
wherein B represents a bond bonded to the group represented by ChHet; A¹ and A² each independently represent a nitrogen atom or ═C(—R¹)—, in which R¹ represents a hydrogen atom or a substituent; and R⁶, R⁷, R⁸, R⁹, R¹⁰, R¹¹, R¹², and R¹³ each independently represent a hydrogen atom or a substituent.

4. The luminous compound as claimed in claim 1, wherein the group represented by ChHet in formula (I) is a group represented by the following formula (V): 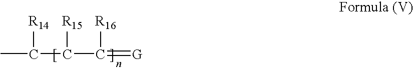
wherein R¹⁴, R¹⁵, and R¹⁶ each independently represent a hydrogen atom or a substituent, and R¹⁴ and R¹⁵, R¹⁵ and R¹⁶, and R¹⁴ and R¹⁶, respectively, may bond with each other to form a ring; n denotes 0, 1, or 2; and G represents an atomic group necessary to form a five- or six-membered nitrogen-containing heterocycle, which heterocycle may form a condensed ring or may be combined with R¹⁴, R¹⁵ or R¹⁶ to form a ring.

5. The luminous compound as claimed in claim 2, wherein, in formula (II), at least one of A¹ and A² represents a nitrogen atom.

6. The luminous compound as claimed in claim 1, wherein the lanthanide ion contained in the group represented by Met is an ion of a metal selected from the group consisting of neodymium, samarium, europium, gadolinium, terbium, and dysprosium.

7. The luminous compound as claimed in claim 1, wherein the lanthanide ion contained in the group represented by Met is a europium ion or a terbium ion.

8. A ligand dye represented by formula (II-b): 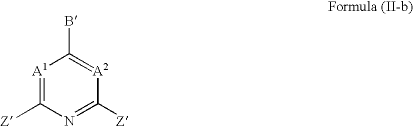
wherein B′ represents a group containing a heterocycle; A¹ and A² each independently represent a nitrogen atom or ═C(—R¹)—, in which R¹ represents a hydrogen atom or a substituent; and Z¹ represents a group containing at least one atom or atomic group which is capable of binding with a lanthanide ion contained in a group having lanthanide ion.

9. A ligand dye represented by formula (III-b) or (IV-b): 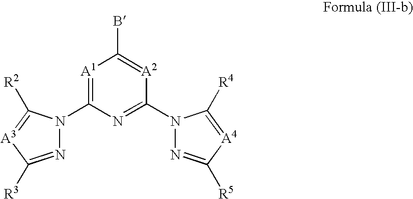
wherein B′ represents a group containing a heterocycle; A¹, A², A³, and A⁴ each independently represent a nitrogen atom or ═C(—R¹)—, in which R¹ represents a hydrogen atom or a substituent; and R², R³, R⁴, and R⁵ each independently represent a hydrogen atom or a substituent; and 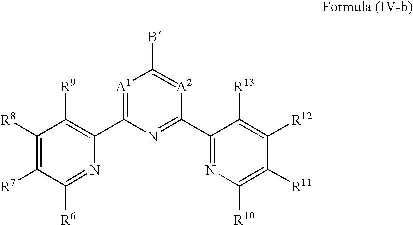
wherein B′ represents a group containing a heterocycle; A¹ and A² each independently represent a nitrogen atom or ═C(—R¹)—, in which R¹ represents a hydrogen atom or a substituent; and R⁶, R⁷, R⁸, R⁹, R¹⁰, R¹¹, R¹², and R¹³ each independently represent a hydrogen atom or a substituent.

10. The luminous compound as claimed in claim 2, wherein the lanthanide ion contained in the group represented by Met is an ion of a metal selected from the group consisting of neodymium, samarium, europium, gadolinium, terbium, and dysprosium.

11. The luminous compound as claimed in claim 2, wherein the lanthanide ion contained in the group represented by Met is a europium ion or a terbium ion.

12. The luminous compound as claimed in claim 3, wherein the lanthanide ion contained in the group represented by Met is an ion of a metal selected from the group consisting of neodymium, samarium, europium, gadolinium, terbium, and dysprosium.

13. The luminous compound as claimed in claim 3, wherein the lanthanide ion contained in the group represented by Met is a europium ion or a terbium ion.

14. The luminous compound as claimed in claim 4, wherein the lanthanide ion contained in the group represented by Met is an ion of a metal selected from the group consisting of neodymium, samarium, europium, gadolinium, terbium, and dysprosium.

15. The luminous compound as claimed in claim 4, wherein the lanthanide ion contained in the group represented by Met is a europium ion or a terbium ion.

16. The luminous compound as claimed in claim 5, wherein the lanthanide ion contained in the group represented by Met is an ion of a metal selected from the group consisting of neodymium, samarium, europium, gadolinium, terbium, and dysprosium.

17. The luminous compound as claimed in claim 5, wherein the lanthanide ion contained in the group represented by Met is a europium ion or a terbium ion.
